(19) United States
(12) Patent Application Publication
(10) Pub. No.: US 2024/0263759 A1
(43) Pub. Date: Aug. 8, 2024

(54) HEAT-DISSIPATION CAR LAMP

(71) Applicant: Huizhou Xunshuo Technology Co., Ltd, Huizhou (CN)

(72) Inventors: Fuyin WANG, Huizhou (CN); Yanzhun LIAN, Huizhou (CN); Longfei ZHANG, Huizhou (CN)

(21) Appl. No.: 18/638,393

(22) Filed: Apr. 17, 2024

(30) Foreign Application Priority Data
Jan. 25, 2024 (CN) 202420188714.9

(51) Int. Cl. F21S 45/48; F21S 45/43; F28D 15/02

(52) U.S. Cl. CPC F21S 45/48; F21S 45/43; F28D 15/02

(57) ABSTRACT

A heat-dissipation car lamp includes a lamp housing and a light source module. The lamp housing is provided with a heat dissipation cavity, an air inlet, and an air outlet. An inside of the heat dissipation cavity is provided with a heat-dissipation fin clinging to a first heat-conducting plate, which is connected to the light source module. The air inlet is provided with a fan fitting the air inlet. The heat-dissipation fin and the first heat-conducting plate seal the interior of the lamp housing. A one-way independent heat-dissipation flow channel is formed through the air inlet, heat dissipation cavity, and air outlet. The air is driven by the fan to flow rapidly through the heat-dissipation fin and exit from the air outlet, and a large amount of heat is carried away, such that the fin is rapidly cooled after absorbing the heat emitted from the light source module.

### CROSS-REFERENCE TO RELATED APPLICATIONS

This application claims the benefit of priority from Chinese patent application Ser. No. 202420188714.9, filed on Jan. 25, 2024. The content of the aforementioned application, including any intervening amendments thereto, is incorporated herein by reference in its entirety.

### TECHNICAL FIELD

This application relates to heat-dissipation technology, more particularly to a heat-dissipation car lamp.

### BACKGROUND

With the rapid development of the automotive industry, car lamps have also gained increasingly diverse functionalities. However, the heat generated by car lamps has also increased. Most of the current car lamps adopt the planar array packaging of LED lights, and thus the interior of the lamps is closed, which will result in the rapid heat accumulation and temperature rise, impacting the service life and effectiveness of the lamps.

Mainstream heat-dissipation structures for car lamps on the market mainly include a main body formed by extrusion and a fan cooling structure, which are sealed in the lamp housing for internal convection circulation. However, the heat-dissipation effect is poor, and the interior of the lamp is prone to continuous temperature rise and heat accumulation, thereby shortening the service life of the wicks. Therefore, there is a need to develop a heat-dissipation structure with independent flow channels for car lamps to address the above issues such as poor internal heat dissipation.

### SUMMARY

The purpose of the present disclosure is to provide a heat-dissipation car lamp to overcome the shortcomings of the prior art.

The technical solutions of the present disclosure are described as follows.

This application provides a heat-dissipation car lamp, comprising:
a lamp housing; and
a light source module;
wherein the lamp housing is provided with a heat dissipation cavity, an air inlet, and an air outlet; a heat-dissipation fin is provided inside the heat dissipation cavity; the heat-dissipation fin clings to a first heat-conducting plate; the first heat-conducting plate is connected to the light source module; the air inlet is provided with a fan; and the fan is matched with the air inlet in shape.

In an embodiment, the air inlet and the air outlet are provided on a rear side of the lamp housing.

In an embodiment, the heat-dissipation fin is provided with a groove; the lamp housing is provided with a limiting plate; and the limiting plate is matched with the groove.

In an embodiment, the fan is provided at a top of the air inlet; and the air inlet communicates with the air outlet through the heat dissipation cavity.

In an embodiment, the first heat-conducting plate is embedded with a heat pipe; and the heat pipe clings to the heat-dissipation fin.

In an embodiment, the heat pipe is made of a high thermal conductivity material; and the heat pipe is S-shaped.

In an embodiment, the light source module comprises a lens, a LED, a second heat-conducting plate, a PCB; and a third heat-conducting plate; the LED is provided on a rear side of the lens; a rear side of the LED is connected to the second heat-conducting plate; a rear side of the second heat-conducting plate is connected to the PCB; a rear side of the PCB is connected to the third heat-conducting plate; and a rear side of the third heat-conducting plate is connected to the first heat-conducting plate.

Due to the adoption of the above technical solution, the heat-dissipation fins and the first heat-conducting plate inside the heat dissipation cavity not only seal the interior of the lamp housing, but also provide the car lamp with waterproof and dustproof functions. A one-way independent heat-dissipation flow channel is formed through the air inlet, heat dissipation cavity, and air outlet. The air driven by the fan flows rapidly through the channel, passes through the heat-dissipation fins, and exits from the air outlet, carrying away a large amount of heat. The heat-dissipation fins absorb the heat generated by the light source module and rapidly dissipate it, effectively preventing heat accumulation inside the lamp housing, significantly enhancing the service life of the wick, and improving the lighting effect.

### BRIEF DESCRIPTION OF THE DRAWINGS

In order to clarify the technical solutions of the embodiments of the present disclosure, a brief introduction to the drawings required in the embodiments will be provided below. It should be understood that the following drawings only illustrate specific embodiments of the present disclosure and should not be construed as limiting the scope of the disclosure. For those skilled in the art, other related drawings can be obtained based on these drawings without making creative effort.

FIG. 1 is a first exploded view of a heat-dissipation car lamp according to an embodiment of the present disclosure;

FIG. 2 is a second exploded view of the heat-dissipation car lamp according to an embodiment of the present disclosure;

FIG. 3 is a perspective view of the heat-dissipation car lamp according to an embodiment of the present disclosure;

FIG. 4 is a sectional view of the heat-dissipation car lamp according to an embodiment of the present disclosure;

FIG. 5 is a front view of a heat-dissipation fin according to an embodiment of the present disclosure.

In the figures: 1—lamp housing, 2—heat-dissipation fin, 3—first heat-conducting plate, 4—heat pipe, 5—fan, 6—heat dissipation cavity, 7—air inlet, 8—air outlet, 9—groove, 10—limiting plate, 11—lens, 12—LED, 13—second heat-conducting plate, 14—PCB, and 15—third heat-conducting plate.

### DETAILED DESCRIPTION OF EMBODIMENTS

For a better understanding of the present disclosure, a more comprehensive description of the present disclosure will be provided with reference to the accompanying drawings. The accompanying drawings merely illustrate preferred embodiments of the present disclosure. However, it should be noted that the present disclosure can be implemented in various forms, and is not limited to the embodiments described herein. These embodiments are intended to facilitate the understanding of the content of the present disclosure.

It should be noted that when a component is referred to as “fixed to” another component, it can be directly fixed on another component or there may be an intermediate component. When a component is considered as “connected to” another component, it can be directly attached to another component or there may be an intermediate component. The terms “vertical,” “horizontal,” “left,” “right,” and similar expressions herein are for illustrative purposes only, and do not limit the implementation manner.

Unless otherwise defined, all technical and scientific terms herein have the same meaning as commonly understood by those skilled in the art to which the present disclosure pertains. The terms used in the description of the present disclosure are intended to describe specific embodiments, and are not intended to limit the present disclosure. The term “and/or” used herein includes any and all combinations of one or more of the associated listed items.

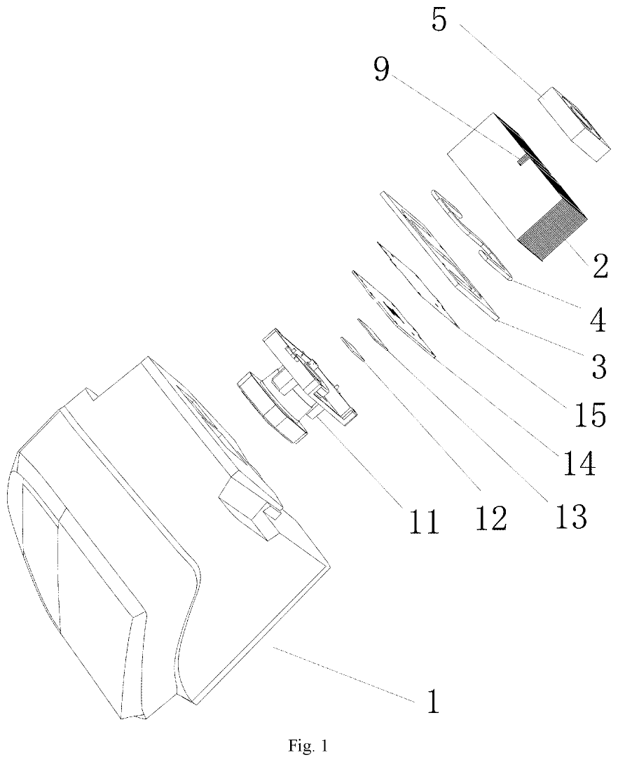

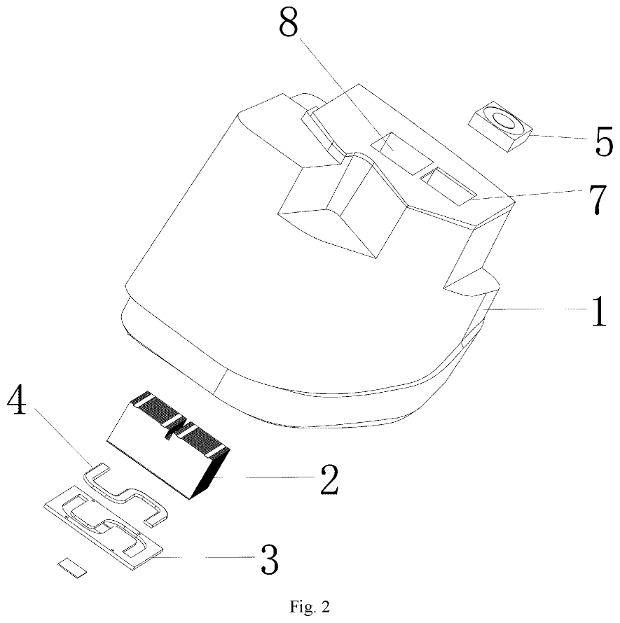

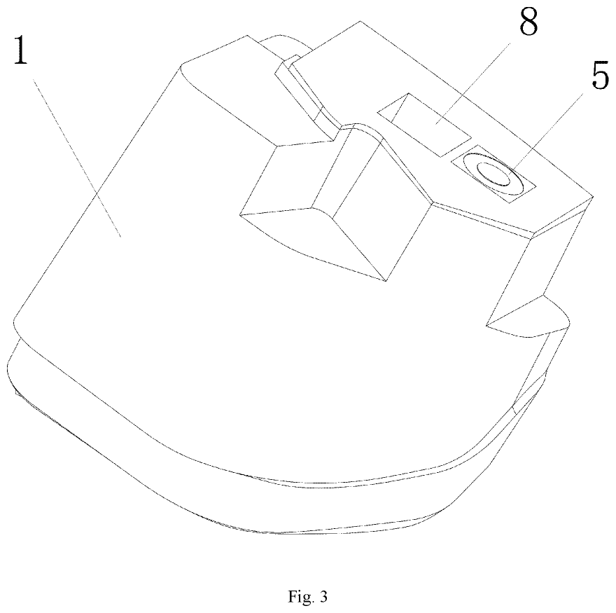

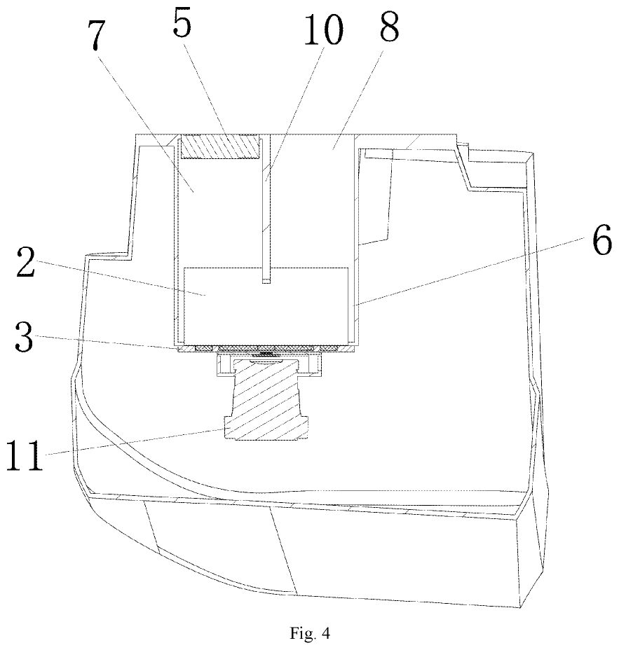

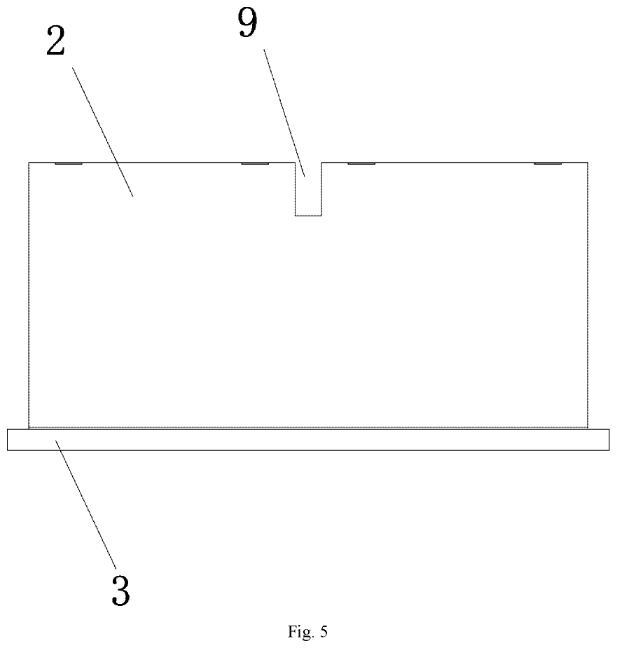

The embodiments of the present disclosure are shown in FIGS. 1-5.

A heat-dissipation car lamp includes a lamp housing 1 and a light source module. The lamp housing 1 is provided with a heat dissipation cavity 6, an air inlet 7, and an air outlet 8. A heat-dissipation fin 2 is provided inside the heat dissipation cavity 6, the heat-dissipation fin 2 clings to a first heat-conducting plate 3, the first heat-conducting plate 3 is connected to the light source module, and the air inlet 7 is provided with a fan 5 with a matching shape.

By adopting the above technical solution, the lamp housing 1, composed of a lampshade, a reflector cup, and the main body of the lamp housing 1, can concentrate the light to ensure the normal propagation of light, and protect the bulb. The heat dissipation cavity 6, the air inlet 7, and the air outlet 8 of the lamp housing 1 are configured to cooperate to form a heat-dissipation flow channel. More heat can be carried away by air passing rapidly through the heat-dissipation flow channel. Moreover, the relatively enclosed space enhances the effect of the heat dissipation. The heat-dissipation fins 2 are disposed of inside the heat dissipation cavity 6 behind the light source module. The heat-dissipation fins 2 cling to the first heat-conducting plate 3, which is connected to the light source module. The first heat-conducting plate 3 conducts the heat generated by the light source module to the heat-dissipation fins 2. The fan 5, which matches the air inlet 7 in shape, drives the air to flow rapidly through the heat-dissipation fins 2 inside the heat dissipation cavity 6. As the air passes through the heat-dissipation fins 2, it takes away a large amount of heat and flows out from the air outlet 8, rapidly dissipating the heat generated by the light source module. This effectively avoids the accumulation of heat inside the lamp housing 1, significantly improving the service life and lighting effect of the lamp. Furthermore, the heat-dissipation fins and the first heat-conducting plate inside the heat dissipation cavity also serve to seal the interior of the lamp housing, providing the car lamp with waterproof and dustproof functions. The heat dissipation module of the car lamp not only ensures sealing but also provides heat dissipation, making the car lamp more durable.

In an embodiment, the air inlet 7 and the air outlet 8 are disposed on the rear side of the lamp housing 1.

By adopting the above technical solution, the air inlet 7 and the air outlet 8 disposed on the rear side of the lamp housing 1 as well as the heat dissipation cavity 6 are configured to cooperate to form a heat-dissipation flow channel, improving the effect of the heat dissipation. Moreover, the air inlet 7 and the air outlet 8 disposed on the rear side do not affect the illumination effect of the car lamp.

In an embodiment, the heat-dissipation fin 2 is provided with a groove 9, the lamp housing 1 is provided with a limiting plate 10, and the limiting plate 10 is matched with the groove 9.

By adopting the above technical solution, the groove 9 is provided at the middle on the top surface of the heat-dissipation fin 2. A limiting plate 10 is provided between the air inlet 7 and the air outlet 8 of the lamp housing 1. The limiting plate 10 is inserted into the groove 9 to prevent the heat-dissipation fins 2 from sliding randomly, serving as a fixing function. The limiting plate 10 separates the air inlet channel and the air outlet channel, forming a one-way passage, which increases the airflow speed.

In an embodiment, the fan 5 is provided at the top of the air inlet 7. The air inlet 7 communicates with the air outlet 8 through the heat dissipation cavity 6.

By adopting the above technical solution, the fan 5 is disposed at the top end of the air inlet 7 blows air into the heat dissipation cavity 6 when activated. This increases the airflow speed and carries away more heat. The air inlet 7 is connected to the air outlet 8 through the heat dissipation cavity 6, forming a one-way independent heat-dissipation flow channel. This arrangement results in fast airflow speed.

In an embodiment, the first heat-conducting plate 3 is embedded with a heat pipe 4, and the heat pipe 4 clings to the heat-dissipation fin.

By adopting the above technical solution, the first heat-conducting plate 3 is embedded with heat pipe 4 with higher thermal conductivity efficiency. The heat pipe 4 clings to the heat-dissipation fins 2 to conduct the heat generated by the light source module to the heat-dissipation fins 2, which then rapidly dissipate the heat.

In an embodiment, the heat pipe 4 is made of a high thermal conductivity material, and the heat pipe 4 is S-shaped.

By adopting the above technical solution, the heat pipe 4 made of high thermal conductivity materials exhibit excellent thermal conductivity performance. The S-shaped heat pipe 4 is relatively easy to fix onto the first heat-conducting plate, thereby satisfying the requirements of both plastic strength and contact area.

In an embodiment, the light source module includes a lens 11, a light emitting diode (LED) 12, a second heat-conducting plate 13, a printed circuit board (PCB) 14; and a third heat-conducting plate 15.

By adopting the above technical solution, the light source module consists of a lens 11, a LED 12, a second heat-conducting plate 13, a PCB 14, and a third heat-conducting plate 15. The lens 11 shapes and guides the light. The LED 12 has high energy efficiency, long service life, and fast response time. When the LED 12 emits light, it generates a considerable amount of heat. The heat generated by the LED 12 is conducted to the PCB 14 by the second heat-conducting plate 13 and is then dissipated by the heat dissipation structure. The PCB 14 connects the light source, control circuit, and vehicle electronic system for communication, enabling the control of the switch and other functions of the car lamp. The third heat-conducting plate 15 conducts the heat generated by the PCB 14 and LED 12 to the heat dissipation structure.

In an embodiment, the LED 12 is provided on a rear side of the lens 11, the rear side of the LED 12 is connected to the second heat-conducting plate 13, the rear side of the second heat-conducting plate 13 is connected to the PCB 14, the rear side of the PCB 14 is connected to the third heat-conducting plate 15, and the rear side of the third heat-conducting plate 15 is connected to the first heat-conducting plate 3.

By adopting the above technical solution, the LED 12 is disposed on the rear side of the lens 11. The rear side of the LED 12 is connected to the second heat-conducting plate 13. The rear side of the second heat-conducting plate 13 is connected to the PCB 14. The rear side of the PCB 14 is connected to the third heat-conducting plate 15. The rear side of the third heat-conducting plate 15 is connected to the first heat-conducting plate 3. The heat is mainly generated when the LED 12 emits light. The heat generated by the LED 12 is conducted to the first heat-conducting plate 3 through the second heat-conducting plate 13, PCB 14, and third heat-conducting plate 15. Finally, the heat is dissipated by the heat-dissipation fins 2 through the first heat-conducting plate 3.

The principle of the heat dissipation of the present disclosure is as follows. The heat-dissipation fins and the first heat-conducting plate seal the interior of the lamp housing, and a one-way independent heat-dissipation flow channel is formed through the air inlet 7, heat dissipation cavity 6, and air outlet 8. This allows the air to flow rapidly within the channel. The heat-dissipation fins 2 inside the heat dissipation cavity 6 absorb heat generated by the light source module and release it to the air. The fan 5 drives the air to flow rapidly through the heat-dissipation fins 2, carrying away a large amount of heat. This allows the rapid dissipation of the heat generated by the light source module, effectively preventing heat accumulation inside the lamp housing.

The installation of the heat-dissipation car lamp is as follows. The lens 11, LED 12, second heat-conducting plate 13, PCB 14, and third heat-conducting plate 15 are sequentially assembled into the light source module. The light source module is mounted inside the lamp housing 1. The internal space of the car lamp is sealed by connecting the first heat-conducting plates 3 and the light source module. Then, the heat-dissipation fins 2 are mounted inside the heat dissipation cavity 6 and are connected to the first heat-conducting plate 3. Finally, the heat-dissipation car lamp is mounted onto the vehicle. The fan 5 is activated according to the requirements. The installation is now complete.

The present disclosure has been described in detail above with reference to several embodiments, but is not limited thereto. It should be noted that for those skilled in the art, various modifications and improvements can still be made to the technical features recited in the above embodiments. It should be understood that those modifications and improvements made without departing from the scope of the present disclosure shall fall within the scope of the present disclosure defined by the appended claims.

What is claimed is:

1. A heat-dissipation car lamp, comprising:
a lamp housing; and
a light source module;
wherein the lamp housing is provided with a heat dissipation cavity, an air inlet and an air outlet;
a heat-dissipation fin is provided inside the heat dissipation cavity;
the heat-dissipation fin clings to a first heat-conducting plate;
the first heat-conducting plate is connected to the light source module;
the air inlet is provided with a fan; and
the fan is matched with the air inlet in shape.

2. The heat-dissipation car lamp of claim 1, wherein the air inlet and the air outlet are provided on a rear side of the lamp housing.

3. The heat-dissipation car lamp of claim 1, wherein the heat-dissipation fin is provided with a groove;
the lamp housing is provided with a limiting plate; and
the limiting plate is matched with the groove.

4. The heat-dissipation car lamp of claim 1, wherein the fan is provided at a top of the air inlet; and
the air inlet communicates with the air outlet through the heat dissipation cavity.

5. The heat-dissipation car lamp of claim 1, wherein the first heat-conducting plate is embedded with a heat pipe; and
the heat pipe clings to the heat-dissipation fin.

6. The heat-dissipation car lamp of claim 5, wherein the heat pipe is made of a thermal conductivity material; and
the heat pipe is S-shaped.

7. The heat-dissipation car lamp of claim 1, wherein the light source module comprises a lens, a light-emitting diode (LED), a second heat-conducting plate, a printed circuit board (PCB), and a third heat-conducting plate;
the LED is provided on a rear side of the lens;
a rear side of the LED is connected to the second heat-conducting plate;
a rear side of the second heat-conducting plate is connected to the PCB;
a rear side of the PCB is connected to the third heat-conducting plate; and
a rear side of the third heat-conducting plate is connected to the first heat-conducting plate.
